(19) United States
(12) Patent Application Publication
(10) Pub. No.: US 2026/0175413 A1
(43) Pub. Date: Jun. 25, 2026

(54) REMOTE OPERATION SYSTEM AND REMOTE OPERATION METHOD

(71) Applicant: KAWASAKI JUKOGYO KABUSHIKI KAISHA, Kobe-shi, Hyogo (JP)

(72) Inventors: Kazuki KURASHIMA, Kobe-shi (JP); Hitoshi HASUNUMA, Kobe-shi (JP); Masayuki KAMON, Kobe-shi (JP)

(73) Assignee: KAWASAKI JUKOGYO KABUSHIKI KAISHA, Kobe-shi, Hyogo (JP)

(21) Appl. No.: 18/856,959

(22) PCT Filed: Apr. 13, 2023
(86) PCT No.: PCT/JP2023/015066

§ 371 Date: Oct. 15, 2024

(30) Foreign Application Priority Data
Apr. 15, 2022 (JP) 2022-067743

(51) Int. Cl. B25J 9/16

(52) U.S. Cl. CPC B25J 9/163; B25J 9/161; B25J 9/1671; B25J 9/1674; B25J 9/1689

(57) ABSTRACT

A remote operation system includes a relay device and a determination device. Operation information detected by a sensor of an operation performed on an operation device is input to the relay device. In response to the operation, the relay device outputs a robot operation command to operate a robot. The determination device inputs at least any of the operation information or information on the robot operation to a machine learning model which has been trained, and determines whether the operation on the operation device is in accordance with the original operation intention using the machine learning model.

### TECHNICAL FIELD

The present disclosure relates to a remote operation of a robot.

### BACKGROUND ART

PTL 1 discloses a mechanical device system in which a robot or other mechanical device is operated by an operation device.

In PTL 1, the control device of the mechanical device has an operation control unit, an arithmetic unit, and an auxiliary unit. The operation control unit controls an operation of the mechanical device according to the operation information output from the operation device. The arithmetic unit includes a machine learning model in which first operation information indicating an operation of the mechanical device is input data and commands of the operation of the mechanical device corresponding to the first operation information are output data. The auxiliary unit outputs auxiliary commands to assist operation in the operation device based on differences between the operation of the mechanical device controlled by the operation control unit and the operation of the mechanical device corresponding to the commands output by the arithmetic unit.

PTL 1 states that the above configuration provides the following effects. That is, by receiving assistance based on the auxiliary commands, the operator can bring his/her own operation closer to the ideal operation acquired by machine learning. As a result, it is possible to pass on the skills of a skilled person regarding the operation of the mechanical device, by using machine learning models.

PRIOR-ART DOCUMENTS

### PATENT DOCUMENTS

PTL 1: Japanese Patent Application Laid-Open No. 2020-192641

### SUMMARY OF THE INVENTION

### Problems to be Solved by the Invention

It is desired to realize functional safety in the robot system. In general robot systems, for example, functional safety is achieved as follows. [1] When a sensor detects that another object has intruded into a movement range of the robot, stop control is performed. [2] If the deviation between a target value and an actual control amount is large regarding the motor torque, it is determined that contact with another object has occurred and stop control is performed.

In a remote-operated robot system, a human gives operation instructions to the robot. Therefore, if a human operates the robot while incorrectly recognizing the work content, the robot operation cannot be stopped unless the situation etc. described in [1] and [2] above occurs. Thus, in the past, it was not possible to achieve substantial functional safety with regard to the robot operation caused by a human remotely instructing the robot to perform an operation that is different from the original operation intention.

PTL 1 mentioned above can improve work quality with respect to the speed of operation, the degree of force, the way of movement, and the like, by making the operator follow the way of the machine learning model, in other words, the way of a skilled person, by means of assistance based on operation differences. However, the configuration of

PTL 1 is not necessarily appropriate for detecting and preventing inappropriate human operations that deviate from the original operation intention, while allowing for a certain degree of deterioration in work quality.

The present disclosure is made in view of the above circumstances, and its purpose is to detect a human operation that deviates from an original operation intention with respect to a remote operation of a robot.

### Means for Solving the Problems

The problem to be solved by the present disclosure is as described above, and next, means for solving the problem and effects thereof will be described.

According to the first aspect of the present disclosure, a remote control system with the following configuration is provided. That is, this remote operation system includes a relay device and a determination device. Operation information detected by a sensor of an operation performed by a human on an operation device is input to the relay device. The relay device outputs a robot operation command to operate a robot in response to the operation information. The determination device inputs at least any of the operation information or information on a state of the robot as input data to a machine learning model which has been trained. The determination device determines whether or not the operation on the operation device is in accordance with an original operation intention based on output of the machine learning model.

According to the second aspect of the present disclosure, a remote operation method as the following is provided. That is, in this remote operation method, a robot operation command is output to operate a robot in response to input of operation information in which an operation performed by a human on an operation device is detected by a sensor. At least one of the operation information and information about a state of the robot is input as input data to a trained machine learning model. The machine learning model is used to determine whether or not the operation on the operation device is in accordance with the original operation intention.

This enables detection of a remote operation of the robot by a human that deviates from the original operation intention.

### Effects of the Invention

According to the present disclosure, with respect to the remote operation of the robot, it is possible to detect a human operation that deviates from the original operation intention.

### BRIEF DESCRIPTION OF THE DRAWINGS

FIG. 1 is a schematic diagram showing a robot system including a remote operation system according to one embodiment of this disclosure.

FIG. 2 is a schematic diagram illustrating a series of operations to be performed by a robot and work processes included in the series of operations.

FIG. 3 is a schematic diagram showing how user operation forces and state values, which constitute work data, are repeatedly acquired.

FIG. 4 is a schematic diagram illustrating the results output by a work process classification model when the operation is performed in accordance with the original operation intention and when the operation is performed with incorrect work procedure.

FIG. 5 is a diagram illustrating a first modification of the robot system.

FIG. 6 is a diagram illustrating a second modification of the robot system.

### EMBODIMENT FOR CARRYING OUT THE INVENTION

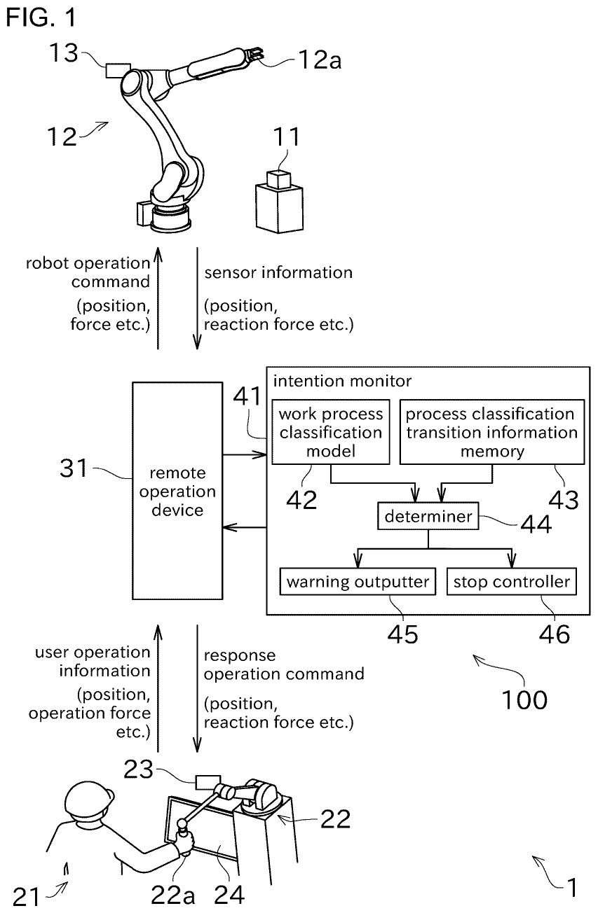

The following description of the disclosed embodiments will be made with reference to the drawings. FIG. 1 is a schematic diagram of a robot system 1 including a remote operation system 100 in accordance with one embodiment of the present disclosure.

The robot system 1 shown in FIG. 1 is a system for performing work using a robot 12. The work to be performed by the robot 12 varies, but may be assembly, machining, painting, cleaning, or the like, for example. The robot system 1 is equipped with a remote operation system 100. The remote operation system 100 allows a user 21 to remotely control the robot 12 using an operation device 22 at his/her hand. The user 21 can be rephrased as an operator.

As shown in FIG. 1, the robot system 1 has the robot 12, the operation device 22, a remote operation device 31, and an intention monitor 41. The remote operation device 31 is a kind of relay device. The intention monitor 41 is a kind of determination device. The robot 12 and the remote operation device 31 are connected to each other by wired or wireless means and can exchange signals. The same is true between the 15 operation device 22 and the remote operation device 31.

The robot 12 has an arm attached to a pedestal. The arm has a plurality of joints, each joint equipped with an actuator. The robot 12 operates the arm by operating the actuators in response to operation commands input externally.

An end effector 12a selected in accordance with the work content to be performed is attached to the end of the arm. The robot 12 performs various operations on a workpiece 11 by operating the end effector 12a in response to robot operation commands input externally.

Sensors are attached to the robot 12 to detect the operation and the surrounding environment, etc. of the robot 12. In this embodiment, a motion sensor, a force sensor, and a camera are provided as the sensors. However, the sensors are not limited to the above and various sensors can be used.

The motion sensor is provided at each joint of the arm of the robot 12 and detects the rotation angle or angular velocity of each joint. The force sensor detects the force received by the robot 12 during the operation of the robot 12. The force sensor may be configured to detect the force applied to the end effector or the force applied to each joint of the arm. The force sensor may be configured to detect moments instead of or in addition to forces. The camera detects the image of the workpiece 11 to be worked on (progress of work on the workpiece 11).

The data detected by the motion sensor are operation data indicating the operations of the robot 12. The data detected by the force sensor and the camera are ambient environment data indicating the environment surrounding the robot 12. In the following description, the set of values of the operation data and the ambient environment data acquired at a certain timing may be referred to as state values. The state values indicate the state of the robot 12 and its surroundings.

In the following description, the motion sensor, the force sensor, and the camera which are attached to the robot 12 may be collectively referred to as state detection sensors 13. The set of values detected by the state detection sensors 13 at a certain timing corresponds to the state values. The state values can be rephrased as sensor information. The state detection sensors 13 may be installed around the robot 12 instead of being attached to the robot 12.

The operation device 22 is a device operated by the user 21. The operation device 22 is configured as an articulated arm device and has an operation part 22a at its tip. The articulated arm device is provided with an actuator, which is not shown in the figure. Instead of an arm-type device, a pedal-type device may be used, for example. As the operation device 22, any known device that constitutes the input side of the user interface may be used.

The operation device 22 includes a known operation force detection sensor 23. The operation force detection sensor 23 detects the operation force applied to the operation device 22 by the user.

In the case where the operation part 22a is configured to be able to be moved in various directions, the operation force may be a value including the direction and magnitude of the force, for example, a vector. The operation force may be detected not only in the form of a force (N) applied by the user, but also in the form of acceleration, which is a value linked to the force (i.e., the force applied by the user divided by a mass of the operation device 22).

In the following description, the operation force applied by the user to the operation part 22a of the operation device 22 may be specifically referred to as the “user operation force”. The user operation force is a type of operation information. The user operation force output from the operation device 22 by the user operating the operation device 22 is converted into robot operation commands by the remote operation device 31 as described below.

A display 24 can display various information in response to user instructions. The display 24 can be, for example, a liquid crystal display. The display 24 is located near the operation device 22. If it is difficult to directly view the robot 12 from the user operating the operation device 22, it is preferable to have the display 24 show images of the robot 12 and its surroundings taken by a camera not shown.

The remote operation device 31 is configured as a known computer. Information such as the user operation force by which the user 21 operates the operation device 22 is input to the remote operation device 31. The remote operation device 31 generates operation commands based on the user operation force and outputs the obtained operation commands to the robot 12. This allows the robot 12 to operate in response to the operation of the user 21 on the operation device 22.

The remote operation device 31 receives sensor information indicating reaction forces and the like received by the robot 12 from the external environment. The remote operation device 31 generates a response operation command based on the reaction force, etc., and outputs the acquired response operation command to the actuators of the operation device 22. This allows the force received by the robot 12 from the outside to be presented to the user 21 in a pseudo manner via the operation device 22.

The intention monitor 41 monitors whether the operations performed by the user 21 on the operation device 22 deviate from the original operation intention that has been predetermined. The intention monitor 41 is connected to the remote operation device 31 and each other by wired or wireless means, and signals can be exchanged.

In the present disclosure, “intention” means an abstraction of the content of a process or operation in terms of, for example, order. For example, in the case of conveying a workpiece, the “intention” is evaluated in terms of which position the workpiece is headed and whether the assumed workpiece is grasped. The “intention” is a relatively large granularity of the content of the process, etc. Therefore, specific differences in the route and speed at which the workpiece is grasped and moved are not evaluated as “intent”, or if they are evaluated, they are not emphasized.

The intention monitor 41 has a work process classification model 42, a process classification transition information memory 43, a determiner 44, a warning outputter 45, and a stop controller 46. The process classification transition information memory 43 is a kind of memory.

The work process classification model 42 is a machine learning model constructed by performing machine learning in advance. The work process classification model 42 is constructed by learning the relationship between the data indicating the operations performed on the operation device 22 and the state of the robot 12, and the work process. The format of the work process classification model 42 is arbitrary, but in this embodiment, a neural network model is used. The construction of the work process classification model 42 is performed in the intention monitor 41 in this embodiment, but may be performed on other computers.

Machine learning performed on the work process classification model 42 will be described in detail. In this embodiment, when constructing the work process classification model 42, the user 21 operates the operation device 22 to repeatedly make the robot 12 perform a predefined operation. At this time, data including the user operation force acquired by the operation force detection sensor 23 and the state value acquired by the state detection sensor 13 are input from the remote operation device 31 to the intention monitor 41. The intention monitor 41 supplies the acquired data to the work process classification model 42 as training data. In the training phase and the inference phase of the work process classification model 42, the user 21 operating the operation device 22 may be the same person or a different person.

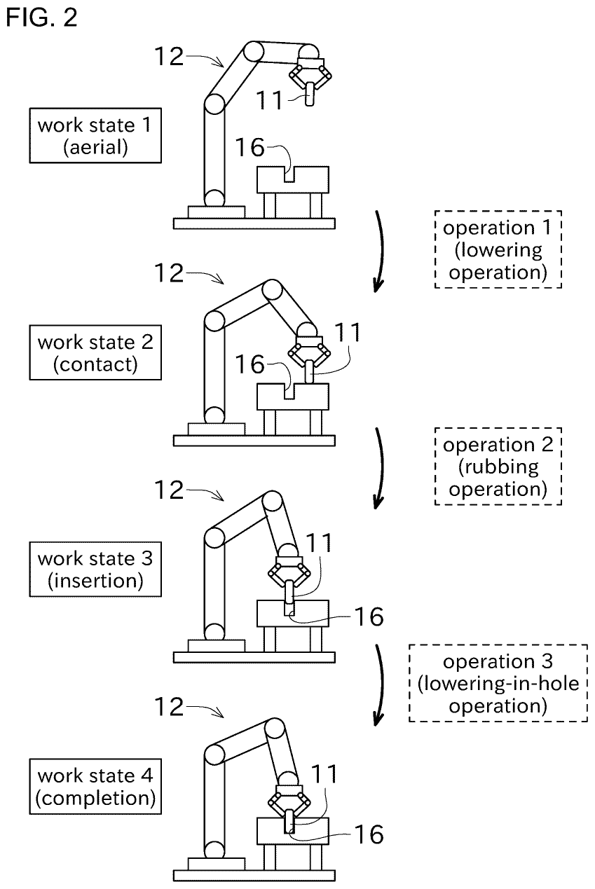

The following is an example of a series of operations to be performed by the robot 12, with reference to FIG. 2.

As shown in FIG. 2, consider the case where the robot 12 is made to perform a series of operations in which the workpiece 11 is placed in the recess 16. From the start to the end of this series of operations, four work states can be considered to appear: aerial, contact, insertion, and completion.

Work state 1 (aerial) is the state in which the robot 12 holds the workpiece 11 and positions it above the recess 16. Work state 2 (contact) is a state in which the robot 12 holds the workpiece 11 and brings it into contact with the surface in which the recess 16 is formed. Work state 3 (insertion) is a state in which the workpiece 11 held by the robot 12 is slightly inserted into the recess 16. Work state 4 (completion) is the state in which the workpiece 11 held by the robot 12 is fully inserted into the recess 16.

The four work states correspond to any of a start state, an intermediate state, and an end state of a series of work by the robot 12. The series of work by the robot 12 is divided into multiple processes with the work state as a boundary. As the robot 12 performs operation corresponding to each process, the work state transitions in the following order: work state 1 (aerial), work state 2 (contact), work state 3 (insertion), and work state 4 (completion).

The data for machine learning can be acquired by the user 21 actually operating the operation device 22 to make the robot 12 perform a series of operations. Hereafter, the data acquired by having the robot 12 perform the series of operations shown in FIG. 2 once may be referred to as work data.

During the process of having the robot 12 perform the series of operations by operating the operation device 22, the user 21 instructs in real time to the intention monitor 41 that the work state has changed when the respective work state is reached. The instruction can be given, for example, by the user 21 operating a pedal not shown in the figure with his/her foot, or by the user 21 vocalizing specific words into a microphone. The operation during the timing when the change in the work state is instructed by the user 21 is treated as a single work process.

The instruction does not have to be given in real time. For example, after the work data has been acquired, at a later time, the user 21 can specify, while viewing the data, at what point the work state has switched.

In the above example, a series of work is divided into multiple work processes at the discretion of the user 21. Alternatively, a series of operations can be automatically divided into multiple work processes using a machine learning model that is separately constructed to classify the work data into multiple work processes. The machine learning model for classification can, for example, be based on clustering techniques, a type of unsupervised learning.

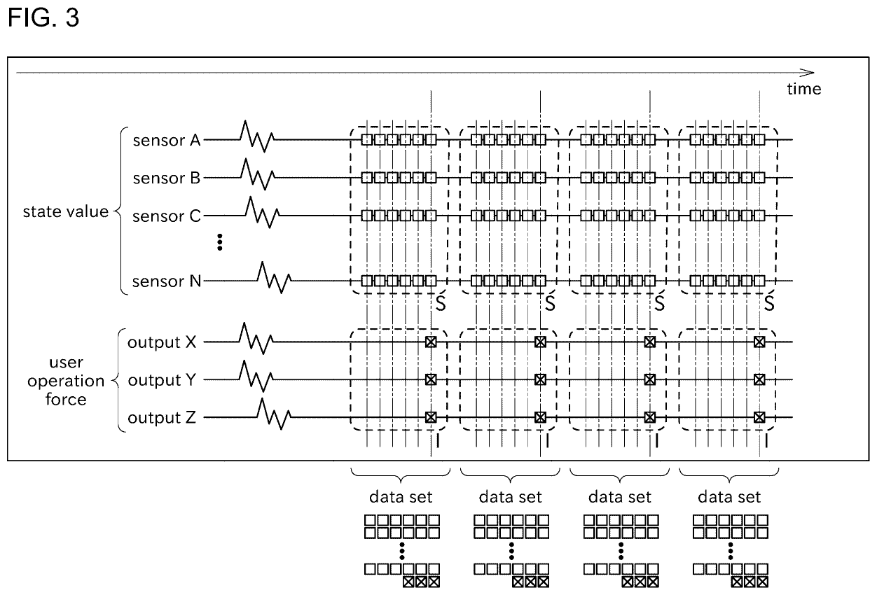

FIG. 3 schematically shows how work data for learning is acquired from various sensors when the user 21 operates the robot 12 to perform a series of operations. Data is repeatedly acquired from the state detection sensor 13 and the operation force detection sensor 23 at appropriate time intervals. In this embodiment, the data acquisition cycle is defined as 1 second, but can be changed as appropriate.

When the robot 12 is performing any work process, a data set is composed from the user operation force and the state values acquired at a certain timing. FIG. 3 shows an example where the time interval of data acquisition for the operation force detection sensor is equal to the data acquisition cycle, while the time interval of data acquisition for the state detection sensor 13 is shorter than the data acquisition cycle. With respect to the state values, in the example in FIG. 3, one data set includes the transition in a short period of time from one previous data acquisition timing to the current data acquisition timing. Thus, one data set may include the time transition of at least any of the state value or the user operation force.

The user 21 specifies a label for each data set. The label expresses which work process the data set belongs to. The label can be a string of characters, for example, “operation 2 (rubbing operation)”. In the training phase, the work process classification model 42 learns the relationship between data sets and labels. For processing convenience, an index number that uniquely identifies the label is predetermined. In the work process classification model 42, labels are handled in the form of index numbers.

Since there is variation in the operations and circumstances of the user 21, there are many variations in operation 2 (rubbing operation) as a work process. In performing machine learning, the user 21 repeatedly operates the operation device 22 to make the robot perform the same series of operations repeatedly. This provides multiple work data, and the work process classification model 42 can learn variations for each work process.

In this embodiment, a machine learning model with a neural network is applied. The machine learning model learns a feature vector that is labeled and represents a set of data (supervised learning). Machine learning by neural network is well known and will not be described here.

Next, the output of the work process classification model 42 in the inference phase will be described.

In the inference phase, the operation force detected by the operation force detection sensor 23 and the state value detected by the state detection sensor 13 are output from the remote operation device 31 to the intention monitor 41. In the intention monitor 41, a data set is generated from the operation force and the state values, and this data set is input as a feature vector to the work process classification model 42. Hereafter, this feature vector may be referred to as the input feature vector. The input feature vector can also be rephrased as input data. The input feature vector may further include the most recent past transition regarding the state values and the most recent past transition regarding the user operation force.

The work process classification model 42 operates in the inference phase to determine the label corresponding to the input feature vectors. This allows the work process to be estimated. The work process classification model 42 outputs the acquired label to the determiner 44.

The process classification transition information memory 43 is configured by a storage device provided by the computer of the intention monitor 41. The process classification transition information memory 43 stores process classification transition information.

The process classification transition information is information indicating the order in which the output of the work process classification model 42 should transition over time when the operation device 22 is correctly operated to cause the robot 12 to perform a series of operations. Specifically, the process classification transition information memory 43 stores that in the process of a series of work of the robot 12, the label of “operation 1 (lowering operation)” should be output first, then the label of “operation 2 (rubbing operation)” should be output, and then the label of “operation 3 (lowering-in-hole operation)” should be output. The stored contents of the process classification transition information memory 43 are output to the determiner 44.

The determiner 44 refers to the stored contents of the process classification transition information memory 43 to determine whether the outputs of the work process classification model 42 appear in the correct order. The determiner 44 outputs the determination result to the warning outputter 45 and the stop controller 46.

For example, consider the case where the work process classification model 42 first outputs the label “operation 3 (lowering-in-hole operation)” in the process of the user 21 performing a series of operations on the operation device 22. Since the order of the work processes does not match the order of the work processes stored in the process classification transition information memory 43, the determiner 44 can determine that the operation of the user 21 on the operation device 22 deviates from the original operation intention.

The warning outputter 45 outputs a warning in an appropriate manner when the determiner 44 determines that the operation of the user 21 to the operation device 22 deviates from the original intention. The warning can be given, for example, by outputting a warning message on the display 24. The warning to the user may be given by other methods such as a buzzer, lamp, etc.

The stop controller 46 can output control signals to the remote operation device 31. The stop controller 46 can control the robot 12 to immediately stop its operation via the remote operation device 31 when the determiner 44 determines that the operation of the user 21 to the operation device 22 deviates from the original intention.

By configuring this embodiment as described above, it is possible to detect at an early stage that the user 21 is trying to make the robot 12 perform work, etc. that is not necessary, by monitoring focusing on the transition of the work process or the order of the operations. In addition, functional safety regarding the operation of the robot 12 can be achieved by the intention monitor 41 without any substantial restriction on the operation of the remote operation device 31.

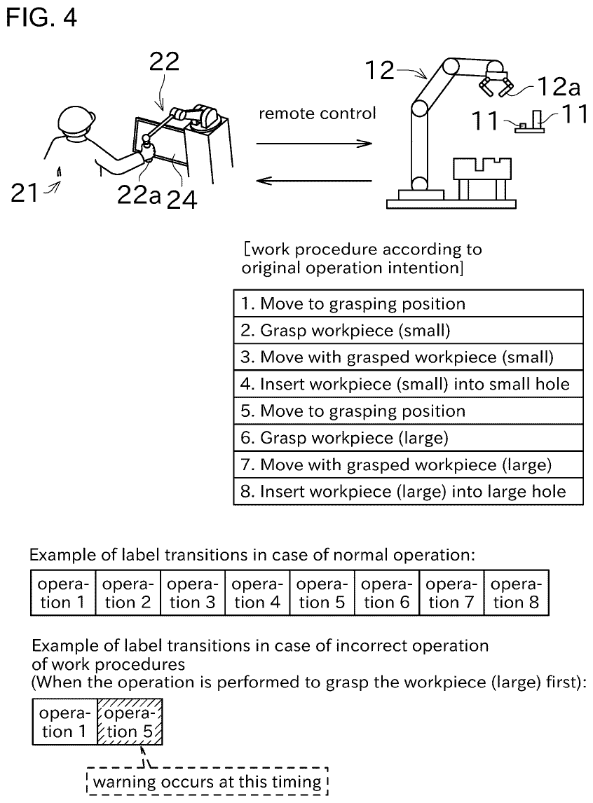

The detection of operations that deviate from the original operation intention will be described below with specific examples. Although different from the example of the work described in FIG. 2, consider the operation of having the robot 12 perform the operation of inserting two workpieces 11 into a hole, as shown in FIG. 4.

In this example, the work procedure is defined as follows. [1] The robot 12 moves to the grasping position. [2] The end effector 12a of the robot 12 grasps the small workpiece 11. [3] The small workpiece 11 is transported to a position just above the small hole. [4] The small workpiece 11 is lowered and inserted into the small hole, and then the end effector 12a releases its grasp. [5] The robot 12 moves to the grasping position. [6] The end effector 12a of the robot 12 grasps the large workpiece 11. [7] The large workpiece 11 is transported to a position just above the large hole. [8] The large workpiece 11 is lowered and inserted into the large hole, and then the end effector 12a releases its grasp.

In the intention monitor 41, eight labels, “operation 1” to “operation 8”, are predetermined as labels for the work process corresponding to the above work procedures [1] to [8]. By learning the relationship between the state values and user operation force acquired at a certain timing and the labels indicating work processes, the work process classification model 42 is constructed in advance.

When the user 21 correctly follows the work procedure described above and operates the operation device 22, the output of the work process classification model 42 is expected to transition in the order of “operation 1”, “operation 2”, “operation 3”, “operation 4”, . . . , “operation 8”. This information is stored in the process classification transition information memory 43.

Assume that the user 21 has operated the operation device 22 so that the robot 12 grasps the large workpiece 11 before the small workpiece 11 because the user 21 has incorrectly recognized the work procedure described above. In this case, the output of the work process classification model 42 will transition so that “operation 5” appears after “operation 1”. When the work process classification model 42 outputs the label “operation 5,” the determiner 44 detects a discrepancy between the transition of the output and the transition stored in the process classification transition information memory 43, and determines that the operation of the user 21 is not in accordance with the original operation intention. As a result, the warning outputter 45 outputs a warning. By the warning operation of the warning outputter 45, the user 21 can notice and correct the error in the work procedure at an early stage.

As a different example from the above, consider the case where the robot 12 is required to perform the operation of placing the workpiece 11 in a predetermined location on a storage shelf. The storage shelf has multiple level shelves. At the stage of constructing the work process classification model 42, different labels are assigned to the process operation depending on which level shelf the workpiece 11 is placed on.

A predetermined work procedure defines that the correct placement of the workpiece 11 is on the first level shelf. Assume that the user 21 has misrecognized the work content and operates the operation device 22 so that the robot 12 places the workpiece 11 on the second shelf. In this case, the label output by the work process classification model 42 does not match the contents stored in the process classification transition information memory 43. Therefore, the determiner 44 determines that the operation of the user 21 is not in accordance with the original operation intention. By the warning given by the warning outputter 45, the user 21 can recognize the error in the work content at an early stage.

As explained above, this embodiment of the remote operation system 100 has the remote operation device 31 and the intention monitor 41. Information on the operation force due to the operation performed by the user 21 on the operation device 22 detected by the operation force detection sensor 23, is input to the remote operation device 31. The remote operation device 31 outputs the robot operation command to operate the robot 12 in response to the information on the operation force. The intention monitor 41 inputs the operation force and the state values as input data to the work process classification model 42 which is the machine learning model which has been trained. The intention monitor 41 determines, based on the output of the work process classification model 42, whether or not the operation on the operation device 22 is in accordance with the original operation intention.

This allows detection of remote operation of the robot 12 by the user 21 to deviate from the original operation intention. Thus, functional safety in the remote operation of the robot 12 can be achieved.

In this embodiment of the remote operation system 100, the work process classification model 42 is configured as a classification model that classifies the operation force and the state values when the user 21 operates the operation device 22 is in accordance with the original operation intention into multiple work processes. The classification results output by the work process classification model 42 are used to determine whether or not the operation on the operation device 22 is in accordance with the original operation intention.

This allows determining whether or not the operation of the user 21 is in accordance with the original operation intention, focusing on the work process to be performed by the robot 12 which is remotely operated.

The remote operation system 100 of this embodiment includes a process classification transition information memory 43. The process classification transition information memory 43 stores process classification transition information in advance. The process classification transition information is the temporal transition of the classification results of the operation force and state values classified by the work process classification model 42 when the user 21 operates the operation device 22 according to the original operation intention. The intention monitor 41 includes the determiner 44. The determiner 44 determines whether or not the operation to the operation device 22 is in accordance with the original operation intention, based on whether or not the transition of the classification results output by the work process classification model 42 matches the process classification transition information.

This allows determining whether or not the operation of the user 21 is in accordance with the original operation intention by monitoring the transition of the work process when the robot 12 performs a series of operations by remote operation.

This embodiment of the remote operation system 100 includes the warning outputter 45. The warning outputter 45 outputs a warning when the intention monitor 41 determines that the operation on the operation device 22 is not in accordance with the original operation intention.

This allows the user 21 to recognize at an early stage that the operation deviates from the original operation intention.

This embodiment of the remote operation system 100 includes the stop controller 46. When the determiner 44 determines that the operation on the operation device 22 is not in accordance with the original operation intention, the stop controller 46 makes the operation of the robot 12 based on the determined operation abort.

This prevents the robot 12 from performing an unnecessary operation, etc.

Next, modifications of the above embodiments will be described.

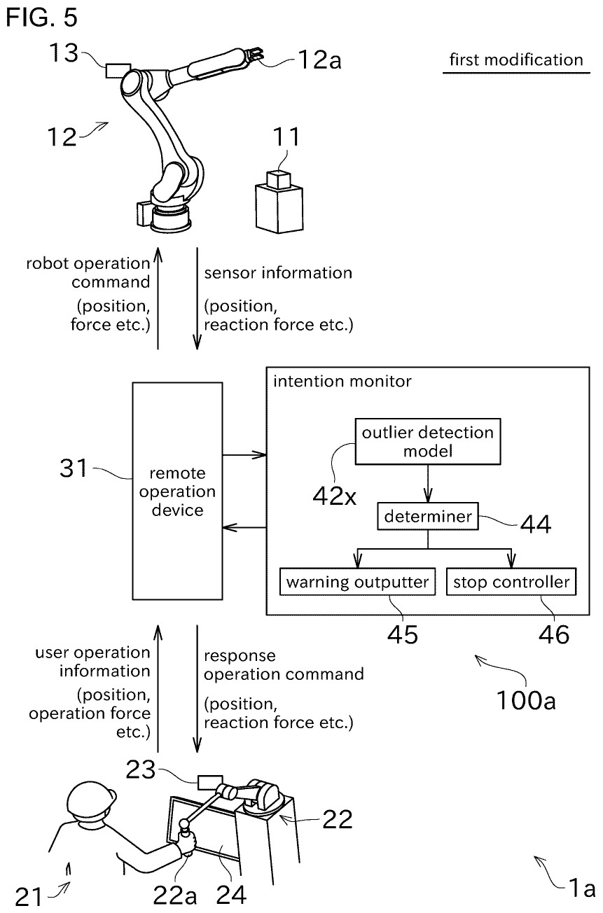

In the embodiment described above, the work process classification model 42 is constructed by performing supervised learning. Instead, a known one-class SVM can be used as the learning model. SVM is an abbreviation for Support Vector Machine. A remote operation system 100a in this configuration is shown in FIG. 5. In description of this first modification, members identical or similar to those of the above-described embodiment are given the same corresponding reference numerals on the drawings, and descriptions thereof may be omitted.

A robot system 1a of the first modification includes is equipped with the remote operation system 100a. In this remote operation system 100a, the intention monitor 41 includes an outlier detection model 42x, which is a kind of machine learning model. In the outlier detection model 42x, outlier detection (in other words, abnormality detection) is performed by unsupervised learning of the one-class SVM. In this modification, the process classification transition information memory 43 is omitted.

In the training phase, the outlier detection model 42x learns feature vectors representing the above data set when the user 21 operates the operation device 22 according to the original operation intention and makes the robot 12 to perform the work. In the one-class SVM, feature vectors are mapped to a higher dimensional space by a known kernel function so that the outliers are closer to the origin. In the one-class SVM, the hyperplane with the largest distance from the origin is defined in the mapping to the higher dimensional space by the kernel function. This hyperplane is the criterion for determining outliers. In the inference phase, the outlier detection model 42x outputs whether the input feature vector is an outlier or not. If the outlier detection model 42x detects an outlier, the determiner 44 determines that the user 21 is operating the operation device 22 with a wrong intention.

In this modification, there is no need to assign labels to the training data, thus reducing the time and effort required to construct the machine learning model.

As explained above, in this modification of the remote operation system 100a, the outlier detection model 42x is a model capable of detecting outliers by learning in advance the operation force and state values when the user 21 operates the operation device 22 according to the original operation intention. The intention monitor 41 includes the determiner 44. The determiner 44 determines whether the operation to the operation device 22 is in accordance with the original operation intention based on whether or not an outlier is detected.

This reduces the effort required to construct the machine learning model.

Next, the second modification will be described. In description of this modification, members identical or similar to those of the above-described embodiment are given the same corresponding reference numerals on the drawings, and descriptions thereof may be omitted.

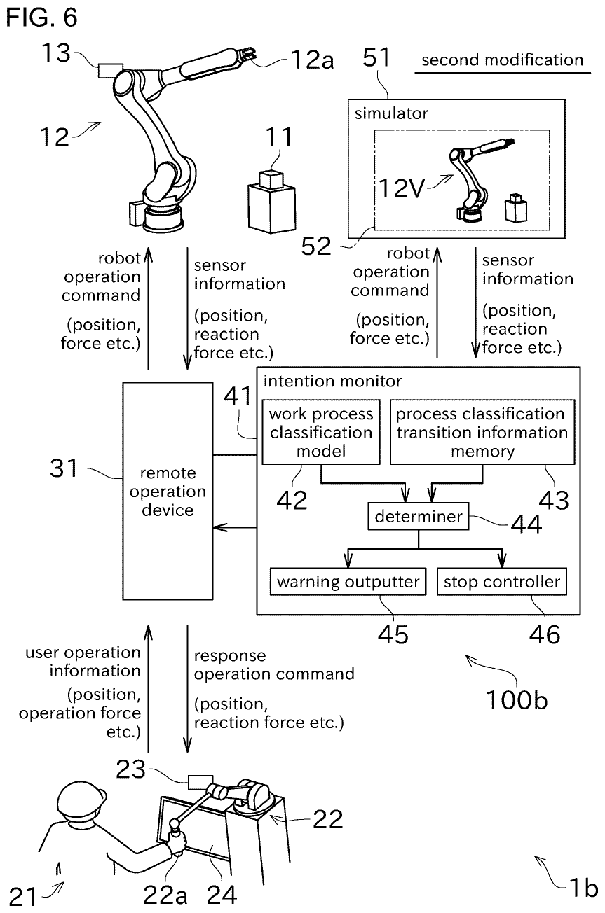

A robot system 1b of this modification shown in FIG. 6 is equipped with a remote operation system 100b. The remote operation system 100b includes a simulator 51 that simulates the operation of the robot 12. The simulator 51 is configured as a known computer and is equipped with a CPU, a ROM, a RAM, and the like. The simulator 51 and the intention monitor 41 are connected to each other by wired or wireless means and can exchange signals.

In the simulator 51, a virtual three-dimensional space 52 is constructed. In this three-dimensional space, a three-dimensional model simulating the robot 12 and a three-dimensional model simulating the workpiece 11 are arranged. The three-dimensional model of the robot 12 may be hereinafter referred to as virtual robot 12V. When a robot operation command is input to the simulator 51, the virtual robot 12V operates to simulate the operation of the robot 12.

The intention monitor 41 outputs robot operation commands to the simulator 51 that are substantially identical to the robot operation commands output by the remote operation device 31 to the robot 12. The simulator 51 operates the virtual robot 12V based on the robot operation commands and performs simulation computation on sensor information such as the position and the reaction force of the virtual robot 12V. The acquired sensor information is output from the simulator 51 to the intention monitor 41.

At a timing before the remote operation device 31 outputs a robot operation command to the real robot 12, the intention monitor 41 outputs the robot operation command to the simulator 51 and acquires the simulation results of the sensor information.

The intention monitor 41 generates input feature vectors based on the user operation force, the simulation results of sensor information, and classifies by the work process classification model 42. Subsequent operations are the same as in the embodiment described above.

In this second modification, the intention monitor 41 can utilize the simulation results to determine whether the operation of the user 21 is in accordance with the original operation intention before the remote operation device 31 outputs the operation command to the real robot 12. Thus, at an earlier stage, the user 21 can be warned or the incorrect operation of the robot 12 can be aborted.

As explained above, the remote operation system 100b of this modification includes the simulator 51 that operates the virtual robot 12V simulating the robot 12, based on the operation commands output by the remote operation device 31. The information regarding the operation of the virtual robot 12V in the simulator 51 is input to the work process classification model 42.

This allows the simulation results simulating the robot 12 to be used to determine whether the operations of the user 21 are in accordance with his/her intentions before actually making the robot 12 perform the operations. Thus, earlier handling can be taken if the operation of the user 21 deviates from the original operation intention.

While some preferred embodiments and modifications of the present disclosure have been described above, the foregoing configurations may be modified, for example, as follows. The modification can be singly made and any combination of several modifications can be made.

The work process classification model 42 used in the intention monitor 41 may be configured to classify work processes using classification methods other than neural networks. For example, classification can be achieved using known methods such as random forests, boosting, DNN algorithms, etc. DNN is an abbreviation for Deep Neural Network. Examples of boosting include Adaboost and XGBoost. Examples of DNN algorithms include LSTM. LSTM is an abbreviation for Long Short Term Memory.

The outlier detection model 42x is not limited to a one-class SVM and can be implemented in various other ways. For example, outliers can be detected by using neural networks such as LSTM or autoencoder, or by using statistical models such as mixed normal distribution models.

In the training and inference phases of machine learning, the feature vector input to the work process classification model 42 or the outlier detection model 42x can be configured in a manner where the state values do not include ambient environment data. The operation forces or the state values of the robot 12 can also be omitted from the feature vector.

The outlier detection model 42x shown in the first modification can also be combined with the simulator 51 shown in the second modification.

Information other than user operation force may be used as the operation information. For example, an operating position, an operating speed, etc. of the operation part 22a in the operation device 22 may be detected by a sensor and included in the operation information.

In the above embodiments and the like, the force received by the robot 12 from the outside is presented to the user 21 in a pseudo manner via the operation device 22.

The present disclosure may be applicable to a remote operation system that does not provide such a pseudo presentation of force.

The present disclosure can be applied to robot systems with mobile manipulators as well as fixed manipulators such as industrial robots. Mobile manipulators can be, for example, humanoid robots, leg-type robots, etc.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. A remote operation system comprising:
a relay device to which operation information detected by a sensor of an operation performed by a human on an operation device is input, and which outputs a robot operation command to operate a robot in response to the operation information,
a determination device that inputs at least any of the operation information or information on a state of the robot as input data to a machine learning model which has been trained, and determines whether or not the operation on the operation device is in accordance with an original operation intention based on output of the machine learning model.

2. The remote operation system according to claim 1, wherein
the machine learning model is configured as a classification model that classifies the input data into a plurality of work processes when a human operates the operation device according to the original operation intention, and
a classification result output by the machine learning model is used to determine whether or not the operation on the operation device is in accordance with the original operation intention.

3. The remote operation system according to claim 2, further comprising a memory that stores process classification transition information which is a temporal transition of the classification result of the machine learning model classifying the input data when a human operates the operation device according to the original operation intention, wherein
the determination device includes a determiner that determines whether or not the operation on the operation device is in accordance with the original operation intention, based on whether or not a transition of the classification result output by the machine learning model matches the process classification transition information.

4. The remote operation system according to claim 1, wherein
the machine learning model is a model capable of detecting an outlier, the model being trained in advance with the input data when a human operates the operation device according to the original operation intention, and
the determination device includes a determiner that determines whether or not the operation on the operation device is in accordance with the original operation intention based on whether or not the outlier is detected.

5. The remote operation system according to claim 1, further comprising a warning outputter that outputs a warning when the determination device determines that the operation on the operation device is not in accordance with the original operation intention.

6. The remote operation system according to claim 1, further comprising
a simulator that operates a virtual robot simulating the robot based on an operation command output by the relay device, wherein
the input data input to the machine learning model includes information regarding an operation of the virtual robot in the simulator.

7. The remote operation system according to claim 1, wherein
when the determination device determines that the operation on the operation device is not in accordance with the original operation intention, the robot aborts to operate based on the determined operation.

8. The remote operation method, comprising:
outputting a robot operation command to operate a robot in response to input of operation information in which an operation performed by a human on an operation device is detected by a sensor; and
determining whether or not the operation on the operation device is in accordance with the original operation intention, using a trained machine learning model to which at least any of the operation information or information on the state of the robot is input as input data.
